(19) United States
(12) Patent Application Publication
(10) Pub. No.: US 2017/0094999 A1
(43) Pub. Date: Apr. 6, 2017

(54) INHALER

(71) Applicant: Kind Consumer Limited, London (GB)

(72) Inventors: Alex HEARN, London (GB); Iain MCDERMENT, Hertfordshire (GB); Khine Zaw NYEIN, Harrow, Middlesex (GB); David John COTTENDEN, Hertfordshire (GB)

(21) Appl. No.: 15/126,895

(22) PCT Filed: Mar. 19, 2015
(86) PCT No.: PCT/GB2015/050800

§ 371 Date: Sep. 16, 2016

(30) Foreign Application Priority Data
Mar. 19, 2014 (GB) 1404945.6

(51) Int. Cl. A24F 47/00; B67D 7/02; F22B 1/28

(52) U.S. Cl. CPC A24F 47/008; F22B 1/284; B67D 7/0238

(57) ABSTRACT

An inhaler comprising a reservoir for an inhalable composition and a heating element and/or vibrating transducer to selectively volatilise at least some components of the composition. A power source supplies electrical power to the heater/transducer when the user inhales from the inhaler. The inhaler further comprises at least one airflow path arranged to draw air in through the inhaler as a user inhales from an inhaling end, and impinge on a plume of composition downstream of the heater/transducer at the inhaling end to reduce the mean particle size of the plume.

The present invention relates to an inhaler.

Conventional E-cigarettes have a volume of inhalable composition, a battery and a heating element to vaporise some of the composition as a user sucks on the end of the cigarette, the vaporised composition then being inhaled.

E-cigarettes are gaining increasing popularity as they provide an alternative to conventional smoking which eliminates the many carcinogens and toxic substances found in tobacco products.

E-cigarettes conventionally use an inhalable composition consisting of a high level of propylene glycol, glycerol, glycerin or glycol in which the nicotine (or alternative such as a flavouring) is solubilised. The high level of propylene glycol causes the composition to be viscous. This is beneficial as it can prevent unwanted evaporation of the composition out of the device and is usually contained in a cotton wadding, pad or other absorbent material. E-cigarettes generally comprise a heater or an ultrasonic atomiser which is in the vicinity of a small amount of the composition volume. Suction on the inlet end causes operation of the heater, and the substance in the vicinity of the heater is evaporated and inhaled. The relatively high viscosity of the composition ensures that the composition available to the heater is gradually replenished but generally prevents it from leaking from the absorbent material in the absence of heat.

While this is reasonably successful, there are two main drawbacks associated with electronic cigarettes. Firstly, the propylene glycol vaporises at a relatively high temperature such that this causes degradation of the composition generally used in E-cigarettes. This can lead to problems with dosage consistency and the presence of contaminants in the inhaled composition including the production of by-products such as formaldehyde, toluene and acrolein.

Secondly, the E-cigarettes require relatively high power to generate the high temperature. Moreover they normally require large batteries to deliver a total dose of vaporised composition to last the user the equivalent of between 20 to 40 cigarettes worth of inhalable composition. The cigarettes have the power to dispense at least one reservoir full of composition. As this large volume is dispensed at a high temperature, a large battery is required. Additionally since larger reservoirs and batteries are used, the nicotine dosage contained in E-cigarettes is high and potentially poses safety concerns when packaged in this format.

Broadly, such E-cigarettes can be divided into three categories, namely rechargeable, refillable and disposable. Those which are rechargeable come with a mains power adaptor. This is cumbersome for a user to carry around as it cannot readily fit into a pocket which is inconvenient. The relatively long recharge time is also inconvenient if a user only remembers that the charge has run down just before they go out.

There are also refillable E-cigarettes which require disassembly of the device and the replacement of the reservoir via a cartridge, liquid or absorbent material. However these are the subject of legal restrictions in many countries due to the availability of drug composition in unsealed containers. Moreover extra care is required in the process of replacing cartridges or material within the device, and extra effort is required by the user to refill which can be cumbersome and messy, especially if composition comes in contact with the skin.

A more recent development is a disposable cigarette. This is designed to last for a time equivalent to approximately 10-20 cigarettes, whereupon the cigarette and its container are thrown away. This is not environmentally friendly, particularly when the cigarette contains a relatively large battery and could be reused or recycled.

The present invention addresses some of the above problems.

According to the present invention there is provided an inhaler comprising a reservoir for an inhalable composition, a heating element and/or vibrating transducer to selectively volatilise at least some components of the composition, and a power source arranged to supply electrical power to the heating element and/or vibrating transducer when the user inhales from the inhaler, further comprising at least one airflow path arranged to draw air in through the inhaler as a user inhales from an inhaling end, and impinge on a plume of composition downstream of the heating element and/or vibrating transducer at the inhaling end to reduce the mean particle size of the plume of the composition.

Such airflow will reduce the mean particle size of the plume. Preferably there is more than one such path, and preferably the paths are arranged to generate swirl around the main axis of the inhaler thereby generating further turbulence and causing greater reduction in particle size.

The airflow paths are preferably arranged to pass through a constriction in the vicinity of the outlet end of the inhaler thereby generating a Venturi effect and promoting suction of the composition out of the inhaler.

The or each airflow may extend all the way from the end opposite to the inhaling end. However, in this case, they have to be routed past the other components in the inhaler. Therefore, preferably, the inlet to the or each airflow path is in the side of the inhaler, and preferably it is closer to the inhaling end than the opposite end. In this way, the airflow paths can be arranged away from the remaining components. Further, by configuring them in this way, they are naturally at an angle to the main axis of the inhaler and therefore this facilitates flow paths which can cause swirl.

The inhaler may have any configuration but is preferably a simulated cigarette.

The effect of the or each airflow path may, on its own, be sufficient to provide the required particle size flow characteristics. However, preferably, the reservoir is pressurised for example using a propellant such as HFA. This pressurised reservoir cooperates with the or each airflow path in order to effectively expel the composition at the required particle size when a user inhales on the inhaling end.

The present invention also extends to a combination of an inhaler and a refill pack, the inhaler comprising a reservoir for an inhalable composition, a heating element and/or vibrating transducer to selectively volatilise at least some components of the composition and at least one inhaler capacitor arranged to supply electrical power to the heating element and/or vibrating transducer when a user inhales from the inhaler; the refill pack comprising a refill reservoir of inhalable composition and a battery coupled to a refill capacitor, and being arranged to engage with the inhaler and to refill the reservoir and recharge the inhaler capacitor from the refill capacitor, the inhaler further comprises at least one airflow path arranged to draw air in through the inhaler as a user sucks on an inhaling end, and impinge on a plume of the composition downstream of the heating element or vibrating transducer at the inhaling end to reduce the mean particle size of the composition.

The inhaler of this combination preferably has all of the preferred features of the inhaler defined above.

Preferably the pack is arranged to fully recharge and refill the inhaler from empty in less than 30 seconds and preferably less than 10 seconds.

The battery may be rechargeable but is preferably not.

Preferably, the refill reservoir is pressurised with a propellant or a compressed gas, the inhaler reservoir having a closable refill valve and the refill pack having a complementary refill valve such that engagement of the inhaler with the pack will cause the two refill valves to open thereby allowing the pressurised composition to flow into the inhaler reservoir.

Preferably, the refill pack is configured such that it will automatically terminate the refill and recharge operations.

An example of a combination of an inhaler and refill pack will now be described with reference to the accompanying drawings, in which:

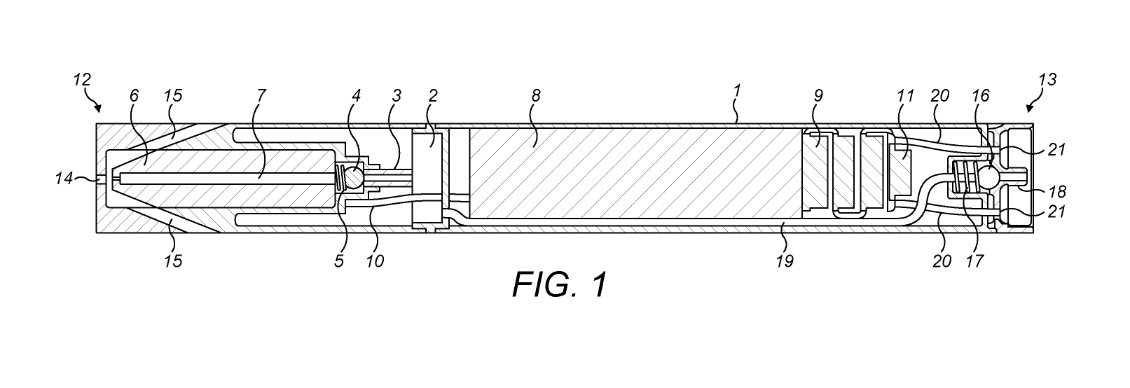

FIG. 1 is a schematic cross-section of an inhaler;

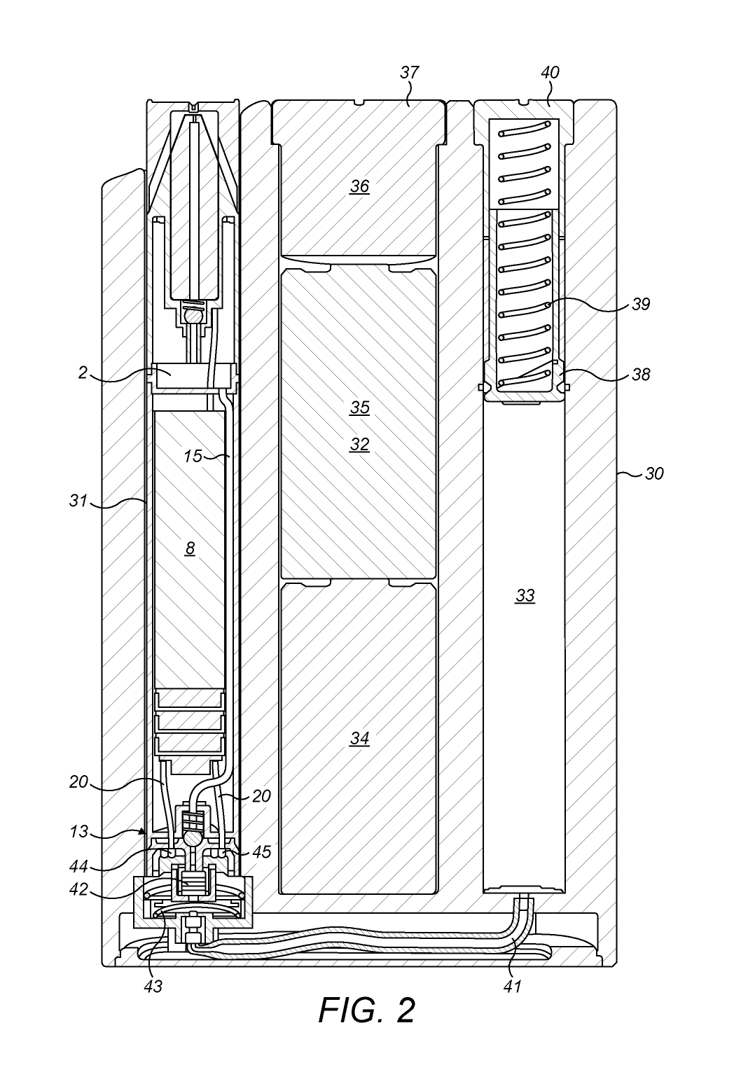

FIG. 2 is a schematic cross-section of an inhaler within a refill pack; and

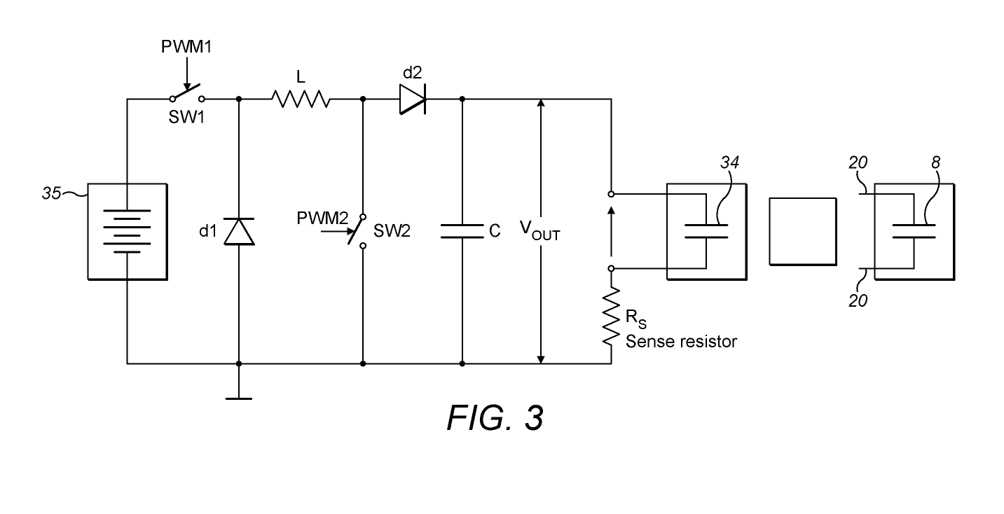

FIG. 3 is a circuit diagram for the recharging operation.

The inhaler described below is one which uses a heating element in order to (at least partially) volatilise the composition. There may, alternatively or additionally, be a vibrating transducer such as a Plezo-electric or ultrasonic transducer which is provided in place of or in addition to the heater to volatilise the composition.

The inhaler is in the form of a simulated cigarette having a generally cylindrical configuration the approximate size of a cigarette.

The inhaler has a cylindrical housing 1 which may be in one or more parts. The housing may be wrapped with a paper-like wrap to provide a more realistic cigarette-like appearance and feel.

Within the housing 1 is a reservoir 2 of inhalable composition. The reservoir 2 has an outlet 3, flow from which is controlled by a ball valve 4 which is opened by an electromagnetic actuator against the action of a spring 5 which biases the ball valve 4 onto the outlet 3. As an alternative, the outlet valve may be a breath operated valve such as that disclosed in WO 2011/015825 and WO 2014/033438. Downstream of the ball valve 4 is a heater 6. This is made of any highly efficient conductive material, preferably fibreglass, and has an internal pathway 7 along its central axis for the passage of composition. The heating element 6 is powered by a super capacitor 8 (also known as an ultra-capacitor). A suitable capacitor is sold by Maxwell Technologies as part of the HC series. This preferably has a capacity of 3-7 F and a diameter of 6 mm to 10 mm and a length of 5 to 50 mm. There may be more than one capacitor provided. FIG. 1 also shows an optional battery 9 which will charge the capacitor 8. However, the current preference is for no battery to be present. The capacitor 8 is connected to the heater 6 by a wire 10. Circuitry 11 is provided to control the operation of the inhaler.

The inhaler has an inhaling end 12 and a refill end 13. The inhaling end is provided with an outlet orifice 14 which is in communication with the internal pathway 7 from the heater. Surrounding the heater 6 in the vicinity of the inhaling end 12 are a number of air paths 15 as shown in FIG. 1. In practice, there may be a number of air paths arranged around the axis, but there are preferably 2 to 4 such passages. These are angled with respect to the main axis of the inhaler as shown. They are also be offset with respect to the axis such they general swirl of the air about the main axis. In particular, the air paths 15 are configured to generate a Venturi effect causing suction in the internal pathway 7 of the heater 6 when a user inhales from the inhaling end 12.

The refill end is provided with a refill valve 16 in the form of a ball valve which opens against the action of a spring 17 which biases the valve closed onto a refill nozzle 18. The refill valve 16 is connected to the reservoir 2 by a refill conduit 19 which extends past the capacitor 8 to provide fluid communication between the refill nozzle 18 and the reservoir 2. A pair of electrical contacts 20 with exposed ends 21 are arranged to provide an electrical connection from the refill end 13 to the opposite terminals of the capacitor 8.

When a user inhales from the inhaling end 12, air flow is detected by a sensor switch (not shown) in the air flow path 15 triggering the current flow from the capacitor 8 to the heater 6 in order to heat the composition. The composition comprises ethanol (boiling point 78.4° C.), nicotine (boiling point 247° C.), propylene glycol (boiling point 180° C.) and HFA (boiling point −26° C.). Thus, by heating the composition to a temperature of under 180° C., all but the nicotine and propylene glycol are volatilised. Preferably the composition is heated to 80° C. which will comprise the ethanol but not the propylene glycol. The result of this heating is a mixture of non-volatilised liquid formation and vapour.

At the same time, the ball valve 4 is opened by the electromagnetic actuator. Thus, the composition in the reservoir 2, which may be pressurised to for example, 6 bar if a propellant is used, leaves the reservoir along the internal pathway 7 assisted by the suction force generated by the airflow in the air paths 15. This airflow also serves to break up the composition ensuring that the plume emitted from the outlet orifice 4 has a fine aerosolisation that promotes higher pulmonary deposition.

The refill pack will now be described by reference to FIG. 2. This shows the inhaler of FIG. 1 inserted into the refill pack with the refill end 13 lowermost. The refill pack is approximately the size and shape of a standard cigarette pack but can have any configuration.

The refill pack comprises a housing 30 and is broadly divided into three sections namely, from left to right (in FIG. 2), a storage port 31 to receive the inhaler, a power supply 32 and a composition refill 33. These are connected across the base of the housing 30 as described below.

The power supply 32 comprises a capacitor 34 which is charged from the battery 35 as shown in FIG. 3. Control circuitry 36 is retained in place by a screw cap 37. The reservoir 33 is pressurised by a plunger 38 which is biased downwardly by a spring 39 held in place by a screw cap 40. The bottom end of the reservoir is connected by a refill duct 41 to a refill valve 42 beneath the inhaler port 31.

The refill valve 42 is a ball valve which is biased closed by a spring and which is opened, in use, by the refill nozzle 18 of the inhaler which presses downwardly on the refill valve 42.

A release spring 43 is provided in the housing 30 underneath the inhaler recess 31. This spring will push the inhaler away from the refilling position to a storage position when the refilling process is complete. This may be done, for example, by releasing the inhaler when a certain priority is detected which indicates that the refill operation is complete.

When the reservoir 2 is depleted of composition, the inhaler is inserted into the housing 30 in the orientation as shown in FIG. 2 and downward pressure is applied to overcome the release spring 42. The refill nozzle 18 opens the refill valve 42 such that the pressure in the reservoir 33 is sufficient to lift the refill valve 16 in the inhaler thereby allowing composition to flow along the refill conduit 19 and link to the reservoir 2. The refill operation is automatically terminated as described above and the release spring urges the inhaler to the storage position.

At the same time as the inhaler is being refilled, the ends 21 of the electrical contacts 20 make contact with inner 44 and outer 45 charging plate rings in the housing 30 which are electrically coupled to the capacitor 43. This causes the inhaler capacitor 8 to be recharged simultaneously with the refill. The recharge circuit is shown in FIG. 3.

1. An inhaler comprising a reservoir for an inhalable composition, a heating element and/or vibrating transducer to selectively volatilise at least some components of the composition, and a power source arranged to supply electrical power to the heating element and/or vibrating transducer when the user inhales from the inhaler, further comprising at least one airflow path arranged to draw air in through the inhaler as a user inhales from an inhaling end, and impinge on a plume of composition downstream of the heating element and/or vibrating transducer at the inhaling end to reduce the mean particle size of the plume of the composition.

2. An inhaler according to claim 1, wherein there is more than one path and wherein the paths are arranged to generate swirl around the main axis of the inhaler.

3. An inhaler according to claim 1, wherein there is more than one path and wherein the airflow paths are arranged to pass through a constriction in the vicinity of the outlet end of the inhaler thereby generating a venturi effect and promoting suction of the composition out of the inhaler.

4. An inhaler according to claim 1, wherein the inlet to the or each airflow path is in the side of the inhaler.

5. An inhaler according to claim 4, wherein the or each inlet is closer to the inhaling end than the opposite end.

6. An inhaler according to claim 1, wherein the inhaler is a simulated cigarette.

7. An inhaler according to claim 1, wherein the reservoir is pressurised.

8. An inhaler according to claim 7, wherein the composition includes a propellant.

9. An inhaler according to claim 8, wherein the propellant is HFA.

10. A combination of an inhaler and a refill pack, the inhaler comprising a reservoir for an inhalable composition, a heating element and/or vibrating transducer to selectively volatilise at least some components of the composition and at least one inhaler capacitor arranged to supply electrical power to the heating element and/or vibrating transducer when a user inhales from the inhaler; the refill pack comprising a refill reservoir of inhalable composition and a battery coupled to a refill capacitor, and being arranged to engage with the inhaler and to refill the reservoir and recharge the inhaler capacitor from the refill capacitor, the inhaler further comprises at least one airflow path arranged to draw air in through the inhaler as a user sucks on an inhaling end, and impinge on a plume of the composition downstream of the heating element or vibrating transducer at the inhaling end to reduce the mean particle size of the plume of the composition.

11. A combination according to claim 10, wherein the pack is arranged to fully recharge and refill the inhaler from empty in less than 30 seconds and preferably less than 10 seconds.

12. A combination according to claim 10, wherein the battery is non-rechargeable.

13. A combination according to claim 9, wherein the refill reservoir is pressurised with a propellant or a compressed gas, the inhaler reservoir having a closable refill valve and the refill pack having a complementary refill valve such that engagement of the inhaler with the pack will cause the two refill valves to open thereby allowing the pressurised composition to flow into the inhaler reservoir.

14. A combination according to claim 9, wherein the refill pack is configured such that it will automatically terminate the refill and recharge operations.
